(19) United States
(12) Patent Application Publication
(10) Pub. No.: US 2014/0178795 A1
(43) Pub. Date: Jun. 26, 2014

(54) SOLID OXIDE FUEL CELL AND METHOD OF MANUFACTURING INTERCONNECTOR FOR SOLID OXIDE FUEL CELL

(71) Applicant: SAMSUNG ELECTRO-MECHANICS CO., LTD., Suwon (KR)

(72) Inventors: Sung Han Kim, Suwon (KR); Jong Ho Chung, Suwon (KR); Jong Sik Yoon, Suwon (KR); Bon Seok Koo, Suwon (KR)

(73) Assignee: Samsung Electro-Mechanics Co., Ltd., Suwon (KR)

(21) Appl. No.: 13/845,037

(22) Filed: Mar. 17, 2013

(30) Foreign Application Priority Data
Dec. 24, 2012 (KR) 10-2012-0152392

(51) Int. Cl. H01M 8/02

(52) U.S. Cl. CPC H01M 8/0247
USPC 429/495; 429/535

(57) ABSTRACT

Disclosed herein is a solid oxide fuel cell including: a unit cell including an anode, an electrolyte, and a cathode; interconnectors having a rugged shape due to a channel and a protruded portion formed on one surface or both surfaces of a body and arranged in parallel at a predetermined interval, wherein a lower surface and a side of the channel are stacked with oxidation resistance insulating ceramic layers. In particular, the present invention includes a method of manufacturing an interconnector for a planar solid oxide fuel cell.

### CROSS REFERENCE TO RELATED APPLICATION

This application claims the benefit of Korean Patent Application No. 10-2012-0152392, filed on Dec. 24, 2012, entitled “Solid Oxide Fuel Cell And Manufacturing Method Of Interconnector For Solid Oxide Fuel Cell” which is hereby incorporated by reference in its entirety into this application.

### BACKGROUND OF THE INVENTION

1. Technical Field

The present invention relates to a solid oxide fuel cell, and more particularly, to a planar solid oxide fuel cell. Further, the present invention includes a method of manufacturing an interconnector for a planar solid oxide fuel cell.

2. Description of the Related Art

Generally, a fuel cell is an apparatus that directly converts fuel (hydrogen, LNG, LPG, and the like) and chemical energy of air (oxygen) into electricity and heat by an electrochemical reaction. Power generation technologies according to the prior art include processes such as fuel combustion, evaporation generation, turbine driving, generator driving, and the like, but a fuel cell does not include the processes of fuel combustion or turbine driving, therefore, the fuel cell is a power generation technology of a new concept which may increase power generation efficiency and does not lead to environmental problems. The fuel cell may little emit air pollutant such as SOX, NOX, and the like, and little generates dioxide carbon to implement pollution-free power generation and has advantages of low noise, no-vibration, and the like.

The fuel cell may include various types such as a phosphoric acid fuel cell (PAFC), an alkaline fuel cell (AFC), a polymer electrolyte membrane fuel cell (PEMFC), a direct methanol fuel cell (DMFC), a solid oxide fuel cell (SOFC), and the like. Among others, the solid oxide fuel cell (SOFC) has low overvoltage and a small irreversible loss based on activation polarization, thereby increasing the power generation efficiency. In addition, as the reaction speed is rapid in an electrode, the solid oxide fuel cell (SOFC) does not need expensive precious metals as an electrode catalyst. Therefore, the SOFC is a power generation technology that is essential to enter hydrogen economy in the future.

Unlike the existing polymer electrolyte membrane fuel cell (PEMFC), the characteristics of the solid oxide fuel cell have a high freedom in selection of fuel as it can use any of the carbon or hydrocarbon-based fuels. Meanwhile, when hydrogen H₂ is used as fuel, the chemical reaction formula will be described through a detailed description of invention.

The existing planar solid oxide fuel cell adopts an interconnector helping a stacking of a unit cell while providing a gas flow channel such as fuel, air, and the like, in which the interconnector may collect electricity generated from unit cells that are arranged on an upper part and a lower part thereof.

For example, International Patent Laid-Open Publication No. WO 2006/138070 (Patent Document 1) discloses an interconnector formed of ferritic stainless steel including chromium, in which the interconnector formed of the ferritic stainless steel slows down an oxide scale growth under the working temperature of the solid oxide fuel cell, but can provide electrical conductivity.

As can be widely known to those skilled in the art, the interconnector formed of a metal alloy is easily oxidized under the high-temperature oxidation atmosphere to form the oxide scale and chromium (Cr) component of the metal alloy is migrated to an electrode or an electrolyte under the high temperature, thereby causing a problem of forming a structure material and a second phase of an electrode or an electrolyte. The problem may degrade the electrical conductivity of the interconnector later, and therefore cannot but degrade the electricity collection efficiency of the solid oxide fuel cell as a whole.

### PRIOR ART DOCUMENT

### Patent Document

(Patent Document 1) Patent Document 1: International Patent Laid-Open Publication No. WO 2006/138070

### SUMMARY OF THE INVENTION

The present invention has been made in an effort to provide an interconnector for a solid oxide fuel cell capable of securing electrical conductivity while providing oxidation resistance.

Further, the present invention has been made in an effort to provide an interconnector of a planar solid oxide fuel cell in which unit cells are stacked in a stack so as to maintain oxidation resistance under high temperature oxidation atmosphere and secure electrical conductivity.

According to a preferred embodiment of the present invention, there is provided a solid oxide fuel cell, including: a unit cell including an anode, an electrolyte, and a cathode; interconnectors having a rugged shape due to a channel and a protruded portion formed on one surface or both surfaces of a body and arranged in parallel at a predetermined interval, wherein a lower surface and a side of the channel are stacked with oxidation resistance insulating ceramic layers.

A ground surface of the protruded portion may be deposited with an oxidation resistance conductive layer.

A circumferential surface of an edge of the body may be stacked with the oxidation resistance insulating ceramic layer.

The body for the interconnector may be formed of a cermet.

An edge of the unit cell and the interconnector may be further provided with a sealing material for blocking gases to be supplied to the interconnector from being leaked to the outside.

The body and the oxidation resistance insulating ceramic layer may include a ceramic material.

The sealing material and the oxidation resistance insulating ceramic layer may include a ceramic material.

The oxidation resistance conductive layer may be formed of platinum (Pt), gold (Au), palladium (Pd), or a mixture thereof.

According to another preferred embodiment of the present invention, there is provided a method of manufacturing an interconnector for a solid oxide fuel cell, including: providing a body formed of a cermet material having a channel and a protruded portion; applying a mask on a ground surface of the protruded portion; stacking an oxidation resistance insulating ceramic layer on the overall surface of the body; and removing the mask.

The method of manufacturing an interconnector for a solid oxide fuel cell assembly may further include: after the removing of the mask, depositing an oxidation resistance conductive layer on the ground surface of the protruded portion.

After the mask is removed, the body may be sintered under reduction atmosphere.

The cermet material may be formed of a mixture of metal powders and ceramic-based powders.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view of a solid oxide fuel cell to which an interconnector according to a preferred embodiment of the present invention is applied;

FIG. 2 is a perspective view of a solid oxide fuel cell stacked in a stack illustrated in FIG. 1;

FIG. 3 is a schematic cross-sectional view of an interconnector according to the preferred embodiment of the present invention; and

FIG. 4 is a manufacturing process diagram of the interconnector illustrated in FIG. 3.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention are described in detail with reference to the accompanying drawings.

Hereinafter, a solid oxide fuel cell and a method of manufacturing an interconnector according to the present invention will be described with reference to the accompanying drawings.

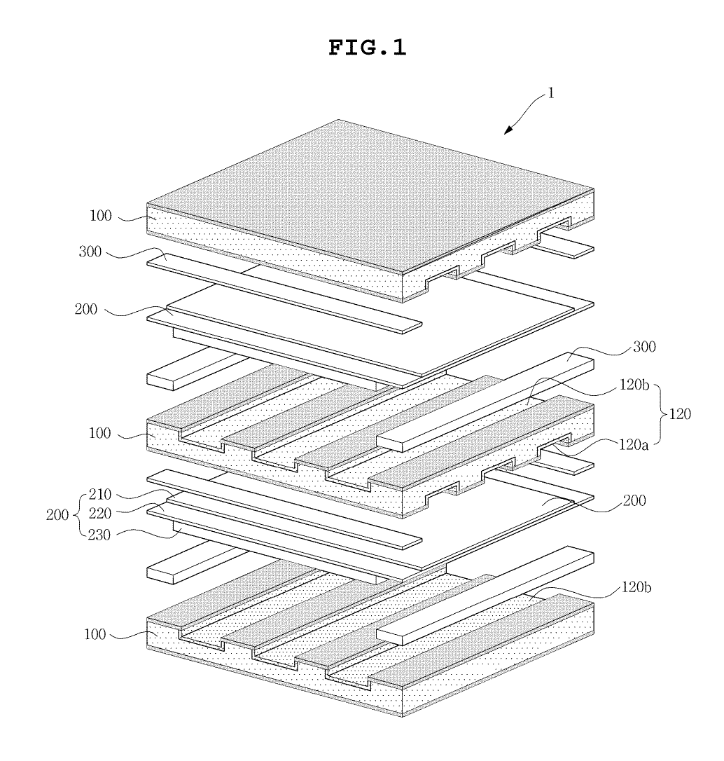

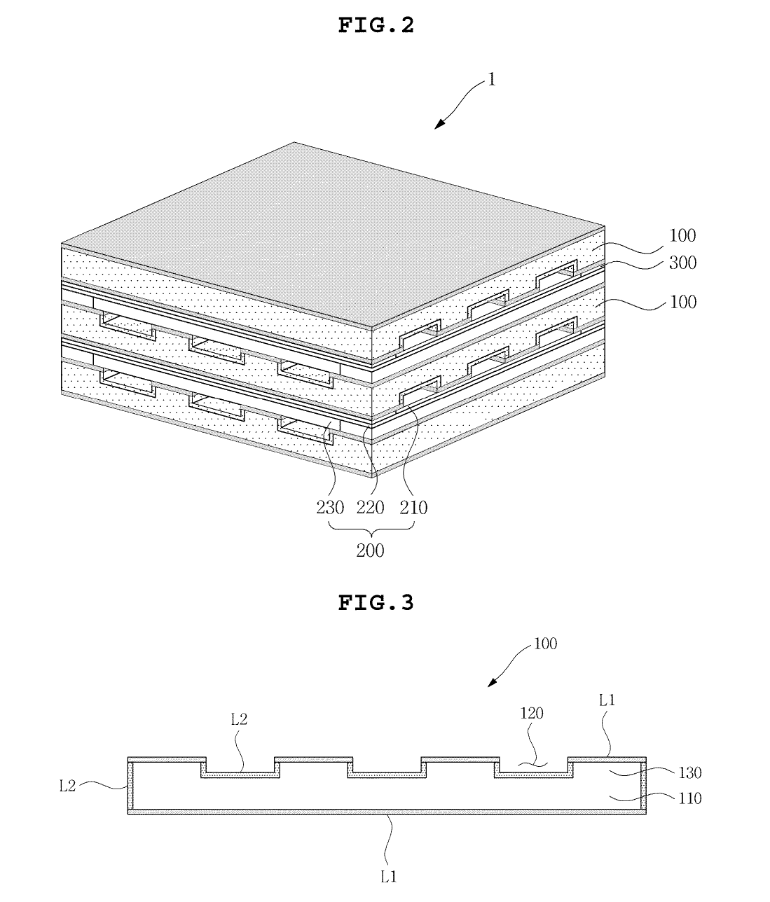

FIGS. 1 and 2 are diagrams schematically illustrating a solid oxide fuel cell to which an interconnector according to a preferred embodiment of the present invention is applied.

Referring to the drawings, a solid oxide fuel cell 1 according to the preferred embodiment of the present invention includes a planar solid oxide fuel cell and is a unit cell 200 in which a planar anode 210, an electrolyte 220, and a cathode 230 are stacked.

As illustrated, the solid oxide fuel cell 1 according to the preferred embodiment of the present invention is configured to include one or more interconnector 100, one or more unit cell 200, and a sealing material 300. In particular, the interconnector 100 includes channels 120, 120a, and 120b that can supply gas (fuel or air) to the unit cell 200.

Herein, the term “interconnector” is basically a component that electrically connects an anode of the unit cell with a cathode of adjacently arranged another unit cell but can physically block air supplied to the cathode and fuel gas supplied to the anode.

In addition, a sealing material 300 is preferably formed of an electrical insulating material helping insulation between the stacked interconnector 100 and the unit cell 200, for example, a ceramic material or a glass material.

The unit cell 200 serves to generate electrical energy and as described above, is formed by stacking an anode 210, an electrolyte 220, and a cathode 230. Generally, in the solid oxide fuel cell (SOFC) 1, when the fuel gas is hydrogen (H₂) or carbon monoxide (CO), the following electrode reaction is performed in the anode 210 and the cathode 230.

Anode: CO+H₂O→H₂+CO₂
2H₂+2O²⁻→4e⁻+2H₂O

Cathode: O₂+4e⁻→2O²⁻

Overall Reaction: H₂+CO+O₂→CO₂+H₂O

Electrons (e⁻) generated in the anode 210 are transferred to the cathode 230 via the external electrode (not illustrated) and at the same time, oxygen ions (O²⁻) generated in the cathode 230 are transferred to the anode 210 via the electrolyte 220. In the anode 210, hydrogen is coupled with oxygen ion to generate electron and water. Consequently, in the overall reaction of the solid oxide fuel cell, when the hydrogen H₂ or carbon monoxide (CO) is supplied to the anode 210 and oxygen is supplied to the cathode 230, carbon dioxide (CO₂) and water (H₂O) are finally generated.

The anode 210 serves as a negative electrode by the electrode reaction with the fuel to be guided to a fuel channel 120a of the interconnector 100. Selectively, the anode 210 is formed of nickel oxide (NiO) and yttria stabilized zirconia (YSZ), in which the nickel oxide is reduced to metal nickel by hydrogen to secure electronic conductivity but the yttria stabilized zirconia (YSZ), which is oxide, secures ion conductivity.

The electrolyte 220 is a vehicle that transfers oxygen ion generated in the cathode 230 to the anode 210 and may be formed by sintering yttria stabilized zirconia or scandium stabilized zirconia (ScSZ), GDC, LDC, and the like. For reference, since a part of the tetravalence zirconium ions is substituted into trivalence yttrium ions, one oxygen ion hole per two yttrium ions is generated in the yttria stabilized zirconia and oxygen ion is migrated through the hole at high temperature. Further, when voids are generated in the electrolyte 220, a cross over phenomenon in which fuel directly reacts with oxygen (air) is generated, and thus the efficiency may be degraded. As a result, it is careful not to generate flaws.

The cathode 230 is supplied with oxygen or air from the air channel 120b of the interconnector 100 to serve as a positive electrode through the electrode reaction. Herein, the cathode 230 may be formed by sintering lanthanum strontium manganite ((La 0.84 Sr 0.16) MnO3) having high electronic conductivity. Meanwhile, in the cathode 230, oxygen is converted into oxygen ion by the catalyst action of lanthanum strontium manganite, and thus transferred to the anode 210 through the electrolyte 220.

As illustrated, the solid oxide fuel cell 1 according to the preferred embodiment of the present invention includes one or more unit cell 200 and FIG. 1 illustrates only two unit cells 200. The interconnector 100 is disposed between two unit cells 200 that are arranged in parallel. As illustrated, an upper surface of the interconnector 100 contacts the cathode 230 of the unit cell 200 under the oxidation atmosphere and a lower surface of the interconnector 100 contacts the anode 210 under the reduction atmosphere.

The interconnector 100 according to the preferred embodiment of the present invention may be preferably formed of cermet. The cermet has heat resistance, oxidation resistance, and wear resistance, and therefore is suitable for the solid oxide fuel cell that is operated under the high-temperature environment. As widely known in advance, the cermet is a material formed by mixing ceramic-based powders that are an inorganic material with metal powders that are a binder and pressing-molding and sintering them.

The interconnector 100 for the solid oxide fuel cell according to the preferred embodiment of the present invention has the channels 120a and 120b each formed on the upper and lower surfaces thereof and the plurality of channels 120a and 120b are formed to longitudinally extend from one end of the upper surface or the lower surface to the other end thereof in parallel. The upper surface of the interconnector 100 has a rugged structure through the plurality of channels 120b and the lower surface thereof has a rugged structure through the plurality of channels 120a. Further, the channels 120a and 120b are formed in an orthogonal direction to each other. The channel 120a through which the fuel gas (hydrogen) passes and the channel 120b through which the air passes are formed so as not to mix the fuel gas with air.

FIG. 3 is a schematic cross-sectional view of an interconnector according to the preferred embodiment of the present invention.

As illustrated in FIG. 1, the interconnector 100 for the solid oxide fuel cell according to the preferred embodiment of the present invention has a rugged shape using the channels 120 each formed on the upper and lower surfaces thereof In detail, the interconnector 100 is configured of the body 110 formed in a rugged shape on one surface or both surfaces (in detail, upper and lower surfaces), an oxidation resistance conductive layer L1 that is stacked on a ground surface (no reference numeral) of a protrude portion 130 of the body 110, and an oxidation resistance insulating ceramic layer L2 that is stacked on a lower surface and a side surface of the channel 120 and on the side of the body 120. Herein, the term “ground surface” is a flat end surface of the protruded portion 130 formed on the upper surface and/or the lower surface of the interconnector 100 and is a member that may conduct electricity by directly contacting the anode or the cathode of the unit cell.

The oxidation resistance conductive layer L1 may be formed of a material having good electrical conductivity while having the oxidation resistance under the high temperature, in particular, preferably, precious metals, for example, platinum (Pt), gold (Au), palladium (Pd), or a mixture thereof. The oxidation resistance conductive layer L1 generates the scale in the vicinity of the protruded portion 130 to prevent the contact resistance from increasing and secure the good electrical contact state with the electrode of the unit cell (not illustrated).

The oxidation resistance insulating ceramic layer L2 is stacked on the lower surface and the side of the channel 120 that may be exposed to the high-temperature oxidation atmosphere. In particular, the channel 120 may maintain the insulated state by being enclosed with the oxidation resistance insulating ceramic layer L2 and can conduct electricity only through the protruded portion 130.

In addition, the oxidation resistance insulating ceramic layer L2 may be formed of a ceramic material, such as zirconium (Zr), and the like and may also be used as a material (for example, YSZ, ScSZ, GDC, and the like) of the electrolyte 220 (see FIG. 1).

Since the oxidation resistance insulating ceramic layer L2 is formed of the same ceramic-based material as or similar ceramic-based material to the body 110 and/or the electrolyte 220 (see FIG. 1), the thermal expansion rates among the oxidation resistance insulating ceramic layer L2, the body 110, or the electrolyte that are induced under the high-temperature environment substantially coincide with one another to provide the alleviation of the thermal impact and/or the thermal stress, thereby improving the durability.

In addition, when the material of the oxidation resistance insulating ceramic layer L2 is composed of the same material as or similar material to the cermet material of the body 110, the materials can stably keep the attached state without being peeled off at the interface therebetween even after the oxidation resistance insulating ceramic layer L2 applied on the side and the lower surface of the channel 120 of the body 110 is sintered.

Selectively, the oxidation resistance insulating ceramic layer L2 may be stacked on the side of the edge of the body 110. As illustrated in FIG. 2, the oxidation resistance insulating ceramic layer L2 is stacked around the edge of the interconnector 100 and the circumference of the edge of the interconnector 100 may contact the sealing material 300 formed of a ceramic material.

The oxidation resistance insulating ceramic layer L2 is formed of a component similar to that of the sealing material 300, thereby improving the thermal stability of the sealing material.

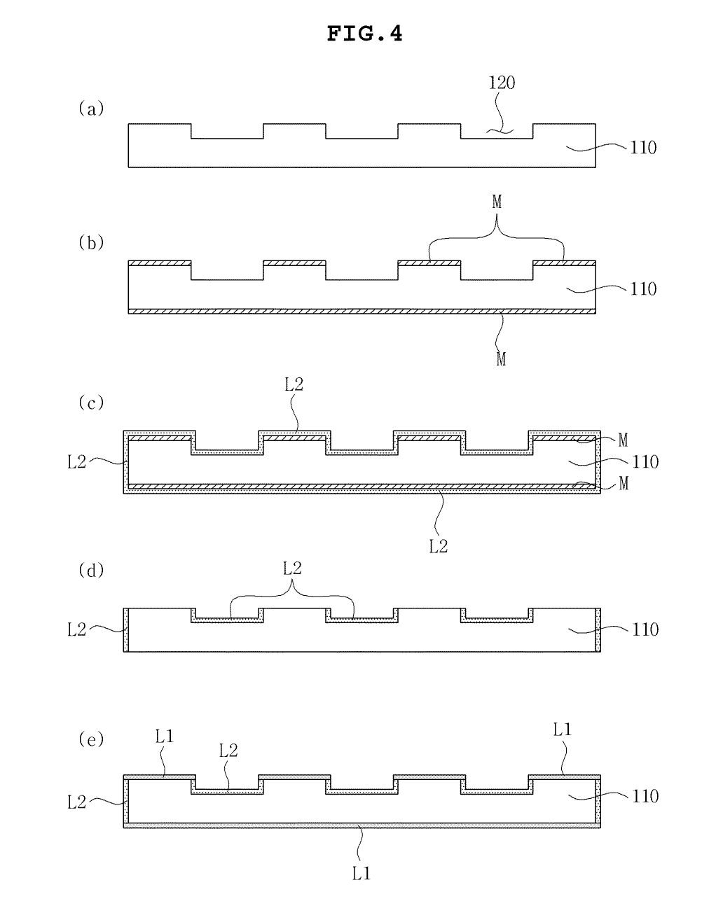

FIG. 4 is a manufacturing process diagram of the interconnector illustrated in FIG. 3.

The interconnector for the solid oxide fuel cell according to the preferred embodiment of the present invention may be manufactured by the following process. For reference, as widely known in advance, the interconnector 100 illustrated in FIG. 4 has a rugged shape by forming the channel on one surface or both surfaces (herein, upper surface and lower surface) and the formation direction of the channel to be formed on the lower surface extends in a direction orthogonal to the formation direction of the channel to be formed on the upper surface. Therefore, it is revealed in advance that the lower surface of the interconnector 100 is displayed only by the protruded portion.

First, FIG. 4A includes a process of providing the body 110 of the interconnector 100 formed of the cermet material. The body 110 is pressed and molded via the cermet formed of a mixture of metal powders and ceramic-based powders, such that the channel 120 may be formed on one surface or both surfaces of the body 110. Further, as described above, the channel 120 is used as a channel of fuel or air to be supplied to the unit cell.

FIG. 4B includes applying a mask M to a portion contacting the electrode (anode or cathode) of the unit cell 200 (see FIGS. 1 and 2). In detail, the mask M may be selectively applied only to the ground surface of the protruded portion 130 of the supplied interconnector 100.

FIG. 4C includes stacking the oxidation resistance insulating ceramic layer L2 on the overall surface of the body 110 after the applying of the mask M. The overall surface of the body 110 may be coated with the oxidation resistance insulating ceramic layer L2 by, for example, a dip coating process. The oxidation resistance insulating ceramic layer L2 is formed on the lower surface and the side of the channel 120 of the body 110 and the side of the edge of the body 110 that are illustrated in FIG. 3.

FIG. 4D includes removing the mask M. At the previous processes, a part of the outer surface of the body 110 and the mask M are coated with the oxidation resistance insulating ceramic layer L2. The ground surface of the protruded portion 130 of the body 110 is exposed to the outside by removing the mask M. For reference, the exposed protruded portion 130 is formed of the cermet including the ceramic.

FIG. 4E includes depositing the oxidation resistance conductive layer L1. As illustrated, the oxidation resistance conductive layer L1 is selectively deposited only the ground surface of the protruded portion 130 of the body 110 from which the oxidation resistance insulating ceramic layer L2 is removed.

Generally, the interconnector 100 is sintered under the high temperature to have rigidity and is sintered under the provided reduction atmosphere by nitrogen, hydrogen, and the like, so as to prevent the metal component of the cermet from being oxidized at the time of sintering. Next, the thin film oxidation resistance conductive layer L1 may be deposited on the exposed portion (that is, the ground surface of the protruded portion 130) of the body 110 by the sputtering, and the like.

The oxidation resistance conductive layer L1 prevents the completed interconnector 100 from being oxidized and contacts the electrode of the solid oxide fuel cell to help the current collection.

As set forth above, according to the preferred embodiments of the present invention, it is possible to provide the solid oxide fuel cell having the interconnector with the oxidation resistance coating so as to be stably used for a long period of time, even when being exposed under the oxidation atmosphere.

According to the preferred embodiments of the present invention, it is possible to stack the unit cells using the interconnector capable of securing the electrical conductivity.

In particular, according to the preferred embodiments of the present invention, the oxidation resistance insulating ceramic layers coated on the body of the interconnector, the electrolyte of the unit cell, and a surface of a part of the interconnector are formed of a similar ceramic material to have a very similar thermal expansion rate under the high-temperature environment, thereby improving the reliable durability against the thermal impact and/or the thermal stress.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A solid oxide fuel cell, comprising:
a unit cell including an anode, an electrolyte, and a cathode;
interconnectors having a rugged shape due to a channel and a protruded portion formed on one surface or both surfaces of a body and arranged in parallel at a predetermined interval,
wherein a lower surface and a side of the channel are stacked with oxidation resistance insulating ceramic layers.

2. The solid oxide fuel cell assembly as set forth in claim 1, wherein a ground surface of the protruded portion is deposited with an oxidation resistance conductive layer.

3. The solid oxide fuel cell assembly as set forth in claim 1, wherein a circumferential surface of an edge of the body is stacked with the oxidation resistance insulating ceramic layer.

4. The solid oxide fuel cell assembly as set forth in claim 1, wherein the body is formed of a cermet.

5. The solid oxide fuel cell assembly as set forth in claim 1, wherein an edge of the interconnector is further provided with a sealing material for blocking gases to be supplied to the interconnector from being leaked to the outside.

6. The solid oxide fuel cell assembly as set forth in claim 1, wherein the body and the oxidation resistance insulating ceramic layer include a ceramic material.

7. The solid oxide fuel cell assembly as set forth in claim 5, wherein the sealing material and the oxidation resistance insulating ceramic layer include a ceramic material.

8. The solid oxide fuel cell assembly as set forth in claim 1, wherein the oxidation resistance conductive layer is formed of platinum (Pt), gold (Au), palladium (Pd), or a mixture thereof.

9. The solid oxide fuel cell assembly as set forth in claim 1, wherein the oxidation resistance insulating ceramic layer is formed of a ceramic material.

10. A method of manufacturing an interconnector for a solid oxide fuel cell, comprising:
providing a body formed of a cermet material having a channel and a protruded portion;
applying a mask on a ground surface of the protruded portion;
stacking an oxidation resistance insulating ceramic layer on the overall surface of the body; and
removing the mask.

11. The method as set forth in claim 10, further comprising:
after the removing of the mask, depositing an oxidation resistance conductive layer on the ground surface of the protruded portion.

12. The method as set forth in claim 10, wherein after the mask is removed, the body is sintered under reduction atmosphere.

13. The method as set forth in claim 10, wherein the cermet material is formed of a mixture of metal powders and ceramic-based powders.
